(19) United States
(12) Patent Application Publication
(10) Pub. No.: US 2012/0306392 A1
(43) Pub. Date: Dec. 6, 2012

(54) LIGHT-EMITTING DIODE NETWORK

(75) Inventors: Whu-Ming YOUNG, Taipei (TW); Ko-Chih CHIU, Taipei (TW); Jacob C. TARN, Hsinchu (TW)

(73) Assignee: TAIWAN SEMICONDUCTOR MANUFACTURING COMPANY, LTD., Hsinchu (TW)

(21) Appl. No.: 13/273,785

(22) Filed: Oct. 14, 2011

Related U.S. Application Data
(60) Provisional application No. 61/492,601, filed on Jun. 2, 2011.

(51) Int. Cl. H05B 37/02

(52) U.S. Cl. 315/192

(57) ABSTRACT

LED devices or circuits include a number of serially connected LED segments, which may additionally include parallel branches, which are switched on or off depending on an input voltage to the LED segments. As the input voltage varies, none, different portions, or all of the LEDs are lit. The input voltage to the LED segments may be an output voltage from a bridge rectifier in response to an alternate current (AC) power. The LED devices or circuits include no inductors, transformers and electrolytic capacitors.

### CROSS REFERENCE TO RELATED APPLICATIONS

The present application claims the priority of U.S. Provisional Patent Application No. 61/492,601, filed on Jun. 2, 2011, which is incorporated herein by reference in its entirety.

### FIELD

The present disclosure is related to a light-emitting diode (LED) network.

### BACKGROUND

Current light-emitting diode (LED) lighting solutions have various deficiencies. In the direct current (DC) driven LED lamps, an AC-DC converter is used to provide the DC current to light a number of LED dies. The AC-DC converter uses many large and inefficient components such as transformers and electrolytic capacitors. Electrolytic capacitors also have bigger capacitance variations, poorer temperature tolerances, and shorter lifetimes compared to other types of capacitors. Thus, while LEDs may be efficient and reliable with long lifetimes, DC-driven LED lamps are not reliable and are expensive because of the AC-DC conversion. In the alternating current (AC) driven LED lamps, the AC power line is coupled to a plurality of lamps, usually in two oppositely connected series. One series of LED lamps are lit when the AC voltage exceeds the sum of the voltage dropped across the lamps coupled in series and dims when the AC voltage reverses polarities to light the other series. Thus, twice the number of LED dies is used to provide discontinuous lighting: neither series is lit when the AC voltage nears zero in the sinusoidal wave. As result, AC-driven LED lamps have poor performance and are inefficient and expensive in terms of the amount of LED die area used.

### BRIEF DESCRIPTION OF THE DRAWINGS

The details of one or more embodiments of the disclosure are set forth in the accompanying drawings and the description below. Other features and advantages will be apparent from the description, drawings, and claims.

FIG. 1 is an example LED circuit in accordance with some embodiments of the present disclosure.

FIG. 2 illustrates voltage and current over time in accordance with various embodiments of the present disclosure.

FIG. 3 is a process flow diagram showing various operations in accordance with various embodiments of the present disclosure.

### DETAILED DESCRIPTION

Embodiments, or examples, illustrated in the drawings are disclosed below using specific language. It will nevertheless be understood that the embodiments and examples are not intended to be limiting. Any alterations and modifications in the disclosed embodiments, and any further applications of the principles disclosed in this document are contemplated as would normally occur to one of ordinary skill in the pertinent art. Reference numbers may be repeated throughout the embodiments, but they do not require that feature(s) of one embodiment apply to another embodiment, even if they share the same reference number.

A Light-Emitting Diode (LED), as used herein, is a semiconductor light source for generating light at a specified wavelength or a range of wavelengths. LEDs are traditionally used for indicator lamps, and are increasingly used for general lighting and displays. An LED emits light when a current is driven across a p-n junction formed by oppositely doping semiconductor compound layers. Different wavelengths of light can be generated using different materials by varying the bandgaps of the semiconductor layers and by fabricating an active layer within the p-n junction. Depending on the semiconductor layer structure, at least an activation voltage, or a forward voltage, is required across the diode in order for the LED to emit light. This forward voltage varies slightly based on operating conditions and the current applied. The forward voltage increases as the current increases, and the relationship can be fitted to a polynomial function. As the current and forward voltage increases, light output also increases, though not in direct proportion to the increase. In other words, beyond the rated current, the LED efficiency decreases as the current increases in a phenomenon known as the droop. Usually, manufacturers define current or current range at which the LED performs relatively efficiently as the “rated” current. Operating current range, within which the LED would emit light, is much larger. For example, higher current (overdriving the LED), in terms of multiples of rated current, can be applied to the LED and resulting in higher light output, though the light efficiency per power applied, quantifiable as “lumens/watt,” decreases. At very high currents, LEDs can burn out.

According to various embodiments, the present disclosure involves LED apparatuses or circuits that include a bridge rectifier, a number of LED segments, switches between the LED segments, and a controller to operate the switches and to control a stepping current based on a varying output voltage from the bridge rectifier. As result, the LED apparatuses or circuits have increased reliability as compared to traditional DC-driven LED apparatuses or circuits, because inductors, transformers and electrolytic capacitors are not used. Additionally, the LED apparatuses or circuits have a reduced LED area as compared to AC-driven LED apparatuses or circuits. Consequently, the LED circuitry is not subject to unreliable operation of those components and related circuits. The electronics cost is therefore reduced. Compared to traditional DC-driven LED approaches, the LED lighting performance in various embodiments remains good, even though cost is reduced. Compared to traditional AC-driven LED approaches, the LED designs reduces LED die area without sacrificing reliability by limiting overdriving of LEDs.

According to various embodiments, the present disclosure also involves a method of operating LEDs. A number of LEDs are connected to a bridge rectifier, which outputs a varying positive voltage in response to alternating current (AC). As the output voltage varies, none, different portions, or all of the LEDs are lit as controlled by a controller using switches.

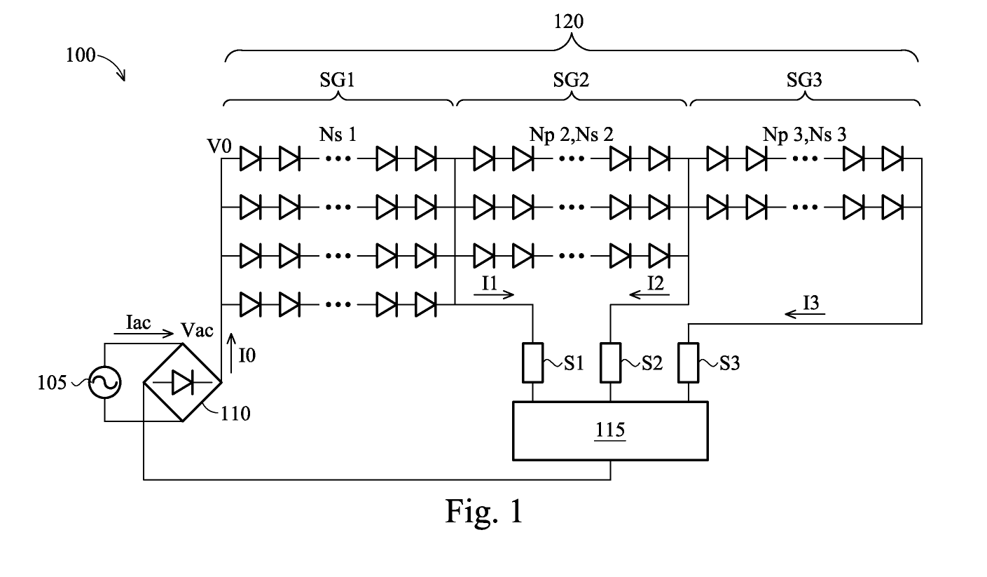

FIG. 1 is a diagram of an LED network 100, in accordance with some embodiments of the present disclosure. Voltage source 105 provides AC voltage Vac and current lac to rectifier 110. In some embodiments, voltage Vac is sinusoidal.

Rectifier 110 receives voltage Vac in the form of full sinusoidal waves having both positive and negative voltages and provides voltage Vo in full wave rectified form having only positive voltages. As referred herein, each half wave of the rectified waveform is referred to as a cycle. A cycle begins when the rectified voltage is at or near zero, has a half point when the rectified voltage is at a maximum, and ends when the rectified voltage is back to the beginning value.

The example LED network 120 of FIG. 1 includes three segments SG1, SG2, and SG3 of LEDs. Each of segment SG1, SG2, and SG3 includes a plurality of LEDs arranged serially in one or more rows (or branches). The LEDs in each segment may have the same or different die areas. For illustration, segment SG1 includes four branches, segment SG2 includes three branches, and segment SG3 includes two branches. Each branch of each segment SG1, SG2, and SG3 includes a number of LEDs, which may vary between different segments but not in parallel branches. Different configurations, i.e., different number of branches per segment and different number of LEDs per branch are within the scope of various embodiments. For illustration, LEDs in segments SG1, SG2, and SG3 are called LED1s, LED2s, and LED3s, respectively.

LEDs in the same segment may be formed on the same die module. A die module includes a number of LED dies with interconnect and passivation layers. The LED dies of a module may be formed on the same growth substrate. A light-emitting structure is first epitaxially grown on a growth substrate, which may be sapphire. The growth substrate with the light-emitting structure is also called an epi wafer. The epi wafer may be divided into LED dies by etching the light-emitting structure into mesas. In one example, the mesas are bonded to a carrier substrate, for example, silicon, before the growth substrate is removed. Various processing are formed on the carrier/LED die package such as depositing passivation layers, lithography, and depositing metal layers to form LED die modules. The carrier substrate may then be diced into separate LED die modules, each module including several LED dies and various layers. The use of die modules allows semiconductor manufacturing techniques to be used in LED manufacturing. If a silicon carrier substrate is used, circuits and devices for the LED may be manufactured first on the silicon substrate and integrated.

LEDs in series may be formed on the same die module by forming interconnect and passivation layers directly on the LED dies bonded to a carrier substrate. Thus, packaging of the LED device is simplified because only the number of dies corresponding to a total number of segments is packaged on the device. Several LEDs in series forming different parallel branches may also be formed on the same die module using the same process to form interconnect and passivation layers. Furthermore, several LED segments may be formed on the same die module with embedded switches or external switches. Embedded switches may be transistors that are externally controlled by the control circuit 115. External switches may connect to the ends of the serial LEDs.

In some embodiments, in a first half of a cycle, all LEDs are off initially, then LED1s in segment SG1 are lit, then LED2s in segments SG2 are lit, then LED3s in segments SG3 are lit. In the second half of the cycle, LED3s continue to light for some time, are then off. LED2s are then off, and LED1s are then off. The lighting of LED1s, LED2s, and LED3s continues in subsequent cycles. At around the half point of the cycle and the maximum voltage, all of the LEDs are lit.

Control circuit 115 controls switches S1, S2, and S3 so that LED1s, LED2s, and LED3s are lit accordingly. For example, when switch S1 is closed while switches S2 and S3 are open, LED1s are lit. When switch S2 is closed while switch S1 and S3 are open, LED1s and LED2s are lit. When switch S3 is closed while switch S1 and S2 are open, all of LED1s, LED2s, and LED3s are lit. Circuit 115 controls switches S1, S2, and S3 based on voltage V0 from the rectifier 110.

In some embodiments, controller 115 closes switch S1, and drives a current I1 through LED1s. When voltage V0 is at a particular voltage sufficient to light LED1s. In other words, when the voltage V0 is at the forward voltage for the SG1 LEDs at current I1, switch S1 is closed and current I1 is driven through controller 115. Voltage V0 increases and continues to increase to a voltage sufficient to light LED1s and LED2s. At that time, circuit 115 opens switch S1, closes switch S2, and drives a current I2. In other words, when the voltage V0 is at the forward voltage for the SG1 LEDs and SG2 LEDs at current I2, switch S1 is opened, switch S2 is closed, and current I2 is driven through controller 115. As a result, LED 1s and LED2s are lit. Voltage V0 continues to increase and when Voltage V0 reaches a forward voltage of LED1s, LED2s, and LED3s, sufficient to light LED1s, LED2s, and LED3s, circuit 115 then opens switch S2, closes switch S3, and drives a current 13. As a result, LED1s, LED2s, and LED3s are lit.

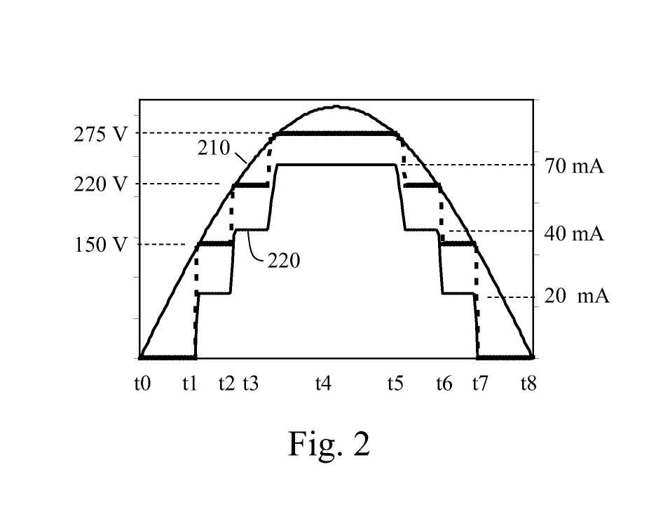

FIG. 2 is a graph of waveforms illustrating the operation of LED network 100, in accordance with some embodiments. The horizontal axis represents time. The first vertical axis on the left shows voltage value of voltage V0 while the second vertical axis on the right shows current value of current I0. Line 210 represents voltage V0 versus time. Line 220 represents current I0 versus time.

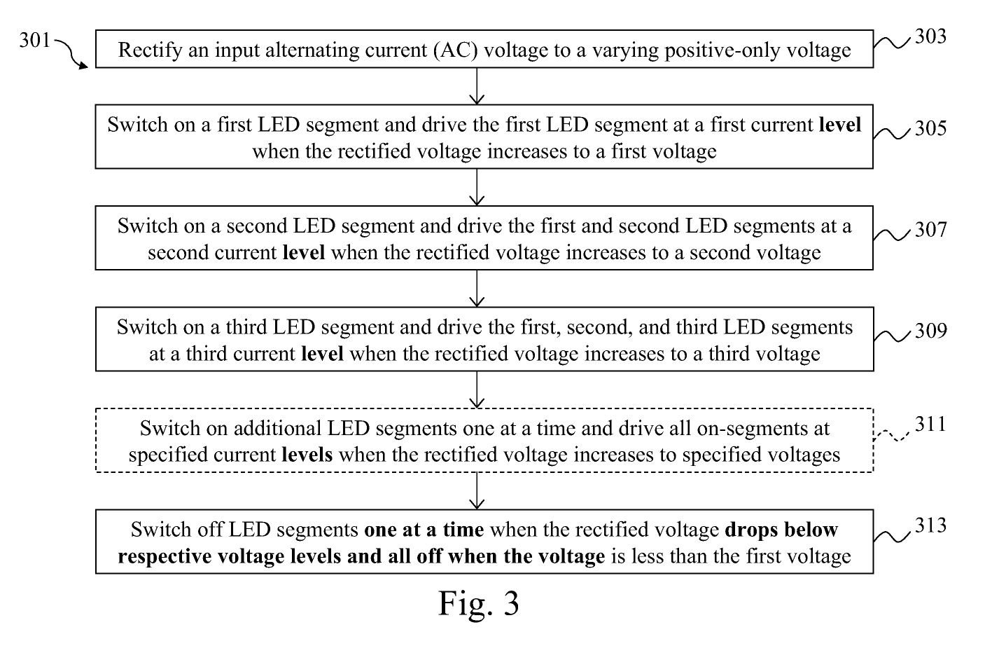

FIG. 3 is a process diagram showing operation of an LED device in accordance with various embodiments of the present disclosure during a cycle. In method 301, the first operation 303 rectifies an input alternating current (AC) voltage to a varying positive-only voltage, voltage V0. Voltage V0 is in the form of a half sinusoidal wave. In the first half of the cycle, voltage V0 increases, and voltage V0 decreases in the second half of the cycle. In FIG. 2, voltage V0 starts at 0V and increases to 300 V in the first half of the cycle. Voltage V0 then decreases from 300 V to 0 V in the second half of the cycle. Initially, all switches S1, S2, and S3, are open. Voltage V0 is at 0 V at time t0. As a result, no LEDs in network 100 are lit. Current I0 equal to 0.

Voltage V0 increases until time t1, as shown in FIG. 2. Then in operation 305 of FIG. 3, a first LED segment is switched on and the first LED segment is driven at a first current density at t1 when the rectified voltage V0 increases to a first voltage. This first voltage is usually the forward voltage for lighting the LEDs in the first segment and can be higher than the forward voltage. In other words, at time t1, circuit 115 detects that voltage V0 at a little over 150 V is sufficient to light LED1s. Circuit 115 closes switch S1. Circuit 115 also sinks a predetermined current, for example, 20 mA as shown in FIG. 2. LED1s are lit. The LED voltage used to light LED1s is about 150 V.

Voltage V0 continues to increase until time t2. In operation 307 of FIG. 3, a second LED segment is switched on and the first and second LED segments are driven at a second current density at t2 when the rectified voltage V0 increases to a second voltage. This second voltage is usually the forward voltage for lighting the LEDs in the first and second segments and can be higher than the forward voltage. In other words, at time t2, circuit 115 detects that voltage V0 at a little over 220 V is sufficient to light LED1s and LED2s. Circuit 115 then opens switch S1 and closes switch S2. Circuit 115 also sinks a predetermined current, for example, about 40 mA. Current I0 is about 40 mA. LED1s and LED2s are lit. The LED voltage used to light LED1s and LED2s is about 220 V.

Voltage V0 continues to increase until time t3. In operation 309 of FIG. 3, a third LED segment is switched on and the first, second, and third LED segments are driven at a third current density at t3 when the rectified voltage V0 increases to a third voltage. This third voltage is usually the forward voltage for lighting the LEDs in the first, second, and third segments and can be higher than the forward voltage. In other words, at time t3, circuit 115 detects that voltage V0 at a little over 275 V is sufficient to light LED1s, LED2s, and LED3s. Circuit 115 then opens switch S2 and closes switch S3. Circuit 115 also sinks a predetermined current, for example, about 70 mA. Current I0 is about 70 mA. LED1s, LED2s, and LED3s are lit. The LED voltage used to light LED1s, LED2s, and LED3s is about 275 V.

In some embodiments, more than 3 LED segments are used. If more segments are used, then in operation 311 additional LED segments are switched on one at a time with corresponding current driven through the “on” LED segments. The additional LED segments are switched on when voltage V0 reaches the forward voltage for the LED segments including the next segment.

In the example of FIG. 2, Voltage V0 continues to increase until time t4, which is the maximum of the half-sinusoidal wave. Voltage V0 then starts decreasing until time t5. At time t5, circuit 115 detects that voltage V0 is about 275 V. A voltage V0 less than 275 V is not sufficient to light all LED1s, LED2s, and LED3s. Circuit 115 then opens switch S3 and closes switch S2. Circuit 115 also sinks a predetermined current, for example, about 42 mA. Thus, the circuit between t5 and t6 is similar to the circuit between t2 and t3: LED1s and LEDs are lit, but LED3s are not lit.

Voltage V0 continues to decrease until time t6. At time t6, circuit 115 detects that voltage V0 is about 220 V. A voltage V0 less than 220 V is not sufficient to light LED1s and LED2s. Circuit 115 then opens switch S2 and closes switch S1. Circuit 115 also sinks a predetermined current, for example, about 40 mA. Thus, the circuit between t6 and t7 is similar to the circuit between time t1 and t2: LED1s are lit, but LED2s and LED3s are not lit.

Voltage V0 continues to decrease until time t7. In operation 313 of FIG. 3, LED segments are switched off one at a time when the rectified voltage is less than the forward voltage of the remaining lit LED segments until all LED segments are turned off when the voltage is less than the first voltage. At time t7, circuit 115 detects that voltage V0 is about 150 V. A voltage V0 less than 150 V is not sufficient to light LED1s. Circuit 115 then opens switch S1. As a result, no LEDs are lit. Current I0 is 0 mA, the same as the current I0 between time t0 and t1. Voltage V0 continues to decrease until time t8, which is the end of the cycle or the beginning of a new cycle corresponding to time t0.

The discussion above uses example step currents. Various embodiments of circuit 100 may be configured. The currents may not step perfectly, or instantaneously. For example, some of the steps or changes may slope. For example, a configuration may be made for low total system power, or high power efficiency, or low total die area. The circuit 100 is configured with a targeted light output (LOP). The targeted light output is usually specified for particular applications in comparison to traditional lighting fixtures. For example, a 1200 lumens lamp is comparable to that emitted by a 75 watt incandescent bulb. In order to make a replacement for 75 watt incandescent bulb, the LED apparatus or lamp would be specified at 1200 lumens.

Another parameter is the light efficacy (Leff) in lumens/watt (lm/W). A light efficacy may be associated with the LED die or the entire system for a particular operating condition. Light efficacy continues to improve. LED dies are available with an Leff of up to about 150 lm/W and LED lamps are available with the system Leff of up to about 120 lm/W. Organizations, such as Energy Star, also specify minimum light efficacy in order to obtain the Energy Star label.

The Leff for an LED die varies with operating conditions. At high currents, the Leff can decrease significantly. As example, an LED die may be specified at 120 lm/W when subjected to a current density of 35 A/cm², which corresponds to a forward voltage (Vf) of about 3.2 V. If the current density decreases, say, to about 25 A/cm², the efficacy increases to 130 lm/W and the Vf decreases to 3.12 V, but the light output also decreases to 75% of the original. At a much higher current density, say, about 70 A/cm², the efficacy decreases to 98 lm/W, the Vf increases to 3.39 V, and the light output increases to 173% of the original. The correlation of Leff, Vf, and light output varies with the current density input, which can be fitted to a curve. However, different LED dies use different curves, fitted for that LED structure design. Note that in the example, the instantaneous power is little more than doubled when the current density is doubled (from 35 to 70 A/cm²), because the Vf also increased slightly, from 3.2 V to 3.39 V. Even though the power is more than doubled, the light output is increased by only 73%.

A total number Nseries of LEDs for circuit 100 is determined based on the AC voltage. The number Nseries is limited by the peak voltage of voltage Vac and the Vf. For example, the peak voltage is about 156 V for 110 Vac, each LED has a Vf range of 3.1 to 3.4 V, the maximum value for number Nseries is 156/3.4 or about 46. For illustration, number Nseries may be 40 to accommodate any high voltage fluctuations. Correspondingly, LED lamps for areas with 220 Vac would have a different number Nseries. The Nseries is the sum of LEDs in one branch for all segments.

The number Ssg of segments and the number Nled of LEDs per segment may be chosen by trial and error to optimize other variables, such as cost, efficiency, and die area. While number Ssg may be any integer greater than one and number Nled is any number greater then zero, a circuit with Ssg of 2 and 1 LED in one segment and 39 LEDs in another segment may be inefficient or use too much die area. A very high number of Ssg may be more efficient, but is very complex with more circuit components and a complicated control scheme, with increase in costs. For illustration, the number of segments Ssg chosen may be 3 to 5.

In one embodiment for a circuit with 3 segments, the number Nled1, Nled2, and Nled3 for segments Sg1, Sg2, and Sg3 are 28, 6, and 6, respectively. In other words, each segment Sg1, Sg2, and Sg3 includes 28, 6, and 6 LEDs, respectively. The number of LEDs Nled1, Nled2, and Nld3 in each segment dictates the forward voltage when the segments are switched on. The forward voltage for each LED depends on the current density through the LED. In a first approximation, the forward voltage is between about 3.1 V and 3.4 V. Because segment Sg1 includes 28 LEDs, and each LED may take 3.3 V to light, the voltage Vs1 used by segment Sg1 is 28*3.3 or about 92 V. Because segment Sg1 includes 6 LEDs, voltage Vs2 used by segment Sg2 is 6*3.3 or about 20 V. Similarly, voltage Vs3 used by segment Sg3 is 20 V because segment Sg3 also includes 6 LEDs like segment Sg2. In this example of three segments, there are three unique current densities that can be identified: I1 between t1/t2 and t6/t7; I2 between t2/t3 and t5/t6; and I3 between t3/t5. Given a set of current densities and the number of LEDs in each segment, the forward voltage at which each segment may be successively switched on may be calculated.

Once the forward voltages are known, the duty cycle for each segment may be calculated. Because the voltage V0 follows a sinusoidal curve, the time at which the forward voltage is reached can be calculated by solving the sine function for the angle at which the sine function reaches the desired forward voltage, then converting the angle to a time, such as t1, t2, and t3.

The total power used by the LEDs may be calculated with the current, forward voltage, and duty cycle for each of the time periods. A light output per die area for each time period may be calculated using the forward voltage, current, efficacy, and duty cycle. This light output per die area is used to find the total die size required to generate a certain amount of light. Generally, the various embodiments of the present disclosure requires more die area than a DC-driven LED circuit because the LEDs are driven less efficiently some of the time and are off some of the time, as opposed to being on all the time at an efficient state. However, the cost difference for the additional LED die area may be more than offset by not using various components in the circuit that are unreliable and costly, such as transformers, capacitors, and inductors.

The total power used by the lamp may be calculated from integrating the varying sinusoidal voltage over the current in each step. Unlike DC-driven LED lamps, the circuit of the various embodiments of the present disclosure does not have a large efficiency loss imposed by components such as capacitors, inductors, and transformers. Thus, the power efficiency (PE), as a percentage of LED power over total power, for the LED lamp in accordance with various embodiments of the present disclosure exceeds that of an equivalent DC-driven LED lamp at the same light output. However, because the LED dies may be operating at a regime of lower efficacy some of the time, the total power required to generate the same amount of light may be higher than that of the DC-drive LED lamp.

The discussion above used the LED die area as a variable that is calculated in the end. If minimizing the LED die area is the goal, then one or more parameters, such as the number of junctions in each segment and the current density in each step, may be varied to find a set of inputs, which results in a minimum total die area. In some embodiments, the current density in each step may stay constant. In other embodiments, only one branch of LEDs is used per segment.

According to various embodiments, a minimum operating current density, for example, between t1 and t2, may be selected at around the rated current density of the LED when light output is more efficient. The maximum current density at the highest forward voltage when all the LEDs are lit may be selected as the maximum operating current density for the LED. For some LEDs, this may be a current density above which the LED warranty would cease to apply, for example, at about 70 A/cm² for a 120 lm/W LED with forward voltage of 3.2 V at 35 A/cm². As light efficacies and LED structures continues to improve, this maximum current density will also increase. Various concepts and embodiments in this disclosure apply to LEDs that have light efficacies and maximum current densities exceeding that of the examples.

In one example configuration, three segments of 28, 6, 6 junctions are used at current densities of 28, 60, and 70 A/cm², respectively. In other words, in the first step 28 junctions are lit at 28 A/cm²; in the second step 34 junctions are lit at 60 A/cm²; and in the third step 40 junctions are lit at 70 A/cm². The average current density over time is 33.3 A/cm². The LED power is about 11.8 W, the total system power is about 13 W, and the power efficiency is about 91%. The total die area is estimated at about 16900 mil², which is about 10.9 mm². Common usage of LED manufacturing refers to die area in units of square mils as opposed to SI units of square millimeters.

In a comparable DC-driven configuration with the same average current density and light output, the total die area is estimated at about 14900 mil², which is about 9.6 mm². The LED power is about 9.9 W, the total system power is about 11.6 W, and the power efficiency is estimated to be 85%.

In a comparable AC-driven configuration, where series of LEDs are lit alternatively depending on whether the input AC voltage is positive or negative, the total die area is about 30000 mil², which is about 19.4 mm². The LED power is about the same as the DC-driven configuration, the total system power is about 11 W, and the power efficiency is estimated to be greater than 90%.

In this comparison, the power efficiency and total power for the example in accordance with the present disclosure is higher than the DC-driven configuration, but comparable to AC-driven configuration. Further, the example uses a somewhat larger total die area to generate the same light output than the DC-driven configuration, but much smaller total die area than the comparable AC-driven configuration. However, as discussed above, the example may nevertheless cost less and last longer because the avoidance of unreliable circuit components.

In another example configuration, three segments of 20, 10, 10 junctions are used at current densities of 20, 40, 70 A/cm², respectively. In other words, in the first step 20 junctions are lit at 20 A/cm²; in the second step 30 junctions are lit at 40 A/cm²; and in the third step 40 junctions are lit at 70 A/cm². The average current density over time is 31.8 A/cm². The LED power is about 11.5 W, the total system power is about 13.1 W, and the power efficiency is about 88%. The total die area is estimated at about 17400 mil², which is about 11.2 mm².

In a comparable DC-driven configuration with the same average current density and light output, the total die area is estimated at about 15400 mil², which is about 9.9 mm². The LED power is about 9.8 W, the total system power is about 11.5 W, and the power efficiency is estimated to be 85%.

In this comparison as in the first example, the power efficiency for the example in accordance with the present disclosure is higher than the DC-driven configuration, but it uses more somewhat power and a larger total die area to generate the same light output. However, as discussed above, the example may nevertheless cost less and last longer because the avoidance of unreliable circuit components.

In yet another example configuration, three segments of 20, 10, 10 junctions are used as in the second example, but all of the steps operate at a constant current density of 54.2 A/cm², with the same average current density and light output. In this configuration, the total die area is slightly smaller than the second example, the LED power is slightly less, with about the same total system power but slightly lower PE.

A number of embodiments have been described. It will nevertheless be understood that various modifications may be made without departing from the spirit and scope of the disclosure. For example, the LED apparatus parameters are for illustration purposes, embodiments of the disclosure are not limited to a particular total light output or a type of LED lamp. Selecting different LED lamp types is within the scope of various embodiments. The various current density level and switching methods used in the above description is also for illustration purposes. Various embodiments are not limited to a particular current density level and selecting different levels is within the scope of various embodiments.

The above methods show exemplary steps, but they are not necessarily performed in the order shown. Steps may be added, replaced, changed order, and/or eliminated as appropriate, in accordance with the spirit and scope of disclosed embodiments.

What is claimed is:

1. A light emitting diode (LED) apparatus comprising:
a plurality of LED segments, wherein each of the plurality of LED segments comprises one or more LED branches, wherein each LED branch comprising a plurality of LED dies connected in series, wherein LED branches within a LED segment are connected in parallel;
switches configured to couple the plurality of LED segments; and,
a controller configured to operate the switches and to control a stepping current based on a input voltage to the plurality of LED segments,
wherein the LED device includes no transformers, inductors, or capacitors.

2. The LED device of claim 1, wherein the plurality of LED segments is three or more segments and the first LED segment comprises more LED branches than the second LED segment.

3. The LED device of claim 1, wherein the controller is configured to perform an operation comprising:
driving a first current through a first LED segment when an input voltage reaches a first voltage;
driving a second current larger than or equal to the first current though the first LED segment and a second LED segment when the input voltage reaches a second voltage larger than the first voltage; and,
driving no current through the plurality of LED segments when the input voltage is less than the first voltage.

4. The LED device of claim 3, wherein the first voltage is a forward voltage for the first LED segment at the first current.

5. The LED device of claim 1, wherein the LED dies in each LED segment have different areas.

6. The LED device of claim 1, wherein a maximum current density with all LED segments switched on is above a rated current density for the LED dies.

7. The LED device of claim 1, wherein a power efficiency ratio of the LED device is about 90% or greater.

8. An LED circuit comprising:
a bridge rectifier;
a plurality of LED segments, wherein each of the plurality of LED segments comprises a plurality of LED junctions and each of the plurality of LED segments are on one die module;
switches configured to couple the plurality of LED segments; and,
a controller configured to operate the switches based on a varying output voltage from the bridge rectifier,
wherein a forward voltage for a total number of LED junctions for all LED segments is less than a maximum output voltage from the bridge rectifier, and
wherein the LED device includes no transformers, inductors, or capacitors.

9. The LED circuit of claim 8, wherein the plurality of LED segments are on one die.

10. The LED circuit of claim 8, wherein each of the plurality of LED segments comprises one or more LED branches connected in parallel.

11. The LED circuit of claim 8, wherein the plurality of LED segments is three or more segments.

12. The LED circuit of claim 8, wherein the controller is configured to
switch on a first LED segment when the output voltage from the bridge rectifier reaches a first voltage, wherein the first voltage is a forward voltage for the first LED segment;
switch on a second LED segment in addition to the first LED segment when the output voltage from the bridge rectifier reaches a second voltage, wherein the second voltage is a forward voltage for the first and second LED segment; and,
switch off all LED segments when the output voltage from the bridge rectifier is less than the first voltage.

13. The LED circuit of claim 12, wherein the controller is further configured to drive a constant current through the plurality of LED segments.

14. The LED circuit of claim 8, wherein a power efficiency ratio of the LED circuit is about 90% or greater.

15. A method comprising:
receiving a varying input voltage;
switching on a first LED segment and driving the first LED segment at a first current density when the input voltage increases to a first voltage, wherein the first voltage is a forward voltage of the first LED segment at the first current density;
switching on a second LED segment and driving the first and second LED segments at a second current density when the input voltage increases to a second voltage, wherein the second voltage is a forward voltage of the first and second LED segments at the second current density;
switching on a third LED segment and driving the first, second, and third LED segments at a third current density when the input voltage increases to a third voltage, wherein the third voltage is a forward voltage of the first, second, and third LED segments at the third current density; and,
switching off all LED segments when the input voltage is less than the first voltage.

16. The method of claim 15, further comprising
switching off the third LED segment when the input voltage decreases to the third voltage and driving the first and second LED segment at the second current density; and,
switching off the second LED segment when the input voltage decreases to the second voltage and driving the first LED segment at the first current density.

17. The method of claim 15, wherein the first current density is about the rated current density for the first LED segment.

18. The method of claim 15, wherein the third voltage is more than about 70% of a maximum input voltage.

19. The method of claim 15, further comprising:
switching on a fourth LED segment and driving the first, second, third, and fourth LED segments at a fourth current density when the input voltage increases to a fourth voltage, wherein the fourth voltage is a forward voltage of the first, second, third, and fourth LED segments at the fourth current density.

20. The method of claim 19, wherein the fourth current density is about or less than a maximum current density.
